(19) United States
(12) Patent Application Publication
(10) Pub. No.: US 2011/0313899 A1
(43) Pub. Date: Dec. 22, 2011

(54) Method of Governing Content Presentation

(76) Inventor: Leonard L. Drey, St. Louis, MO (US)

(21) Appl. No.: 12/965,421

(22) Filed: Dec. 10, 2010

Related U.S. Application Data
(63) Continuation-in-part of application No. 11/620,512, filed on Jan. 5, 2007.
(60) Provisional application No. 60/756,467, filed on Jan. 5, 2006.
(60) Provisional application No. 60/758,447, filed on Jan. 12, 2006.

(51) Int. Cl. G06F 17/21; G06Q 30/00

(52) U.S. Cl. 705/30; 715/205; 715/230; 715/234; 715/273

(57) ABSTRACT

A method of governing content presentation includes creating a variable computer-readable document file that includes primarily textual content. A delimiter is inserted at a predetermined position of the textual portion, defining delimited content. A viewer accesses the document file and consumes the associated content. A number of predetermined actions and/or events occurring while consuming content is tracked. An integrated device includes a storage medium, a microprocessor device, and an electronic display device. The storage medium includes instructions that can be implemented by the microprocessor device to cause a document to be displayed on the electronic display device according to the described method.

### CROSS-REFERENCE TO RELATED APPLICATIONS

This is a continuation-in-part of U.S. patent application Ser. No. 11/620,512, which was filed on Jan. 5, 2007, and which in turn is related to, and claims the benefit under 35 USC §119(e) of U.S. Provisional Application for Patent No. 60/756,467, which was filed on Jan. 5, 2006, and U.S. Provisional Application for Patent No. 60/758,447, which was filed on Jan. 12, 2006.

### FIELD OF THE INVENTION

The invention relates to methods of presenting content to a viewer, for example, on an electronic display device. In particular, the invention relates to control over the timing of the presentation of the content.

### BACKGROUND OF THE INVENTION

Content, and text in particular, is usually presented in static fashion. That is, when a reader reads text and other content in hard-copy form, text and images do not change, and subtle nuances in the meaning of what is conveyed in the content must be expressed through the careful use of words and static images. Content provided to a viewer on a computer has the potential to overcome this constraint, but this capability is underutilized. A need exists to more fully utilize the capability of electronic media, so that dynamic content can be provided that transcends static limitations of expression.

### BRIEF SUMMARY OF THE INVENTION

According to an aspect of the invention, a method of tracking and governing content consumption includes creating a document file, for example, creation of a document file by a writer or author. Preferably, this content is associated in a single document with a pre-existing, largely unchanging program file that controls presentation of the new material to a viewer. The document file is a computer-readable file that includes content, which is primarily textual. At least one delimiter is inserted at a position of the textual portion of the document file, selected by the author, to define delimited content. The document file is provided to a viewer, who accesses the document file and consumes the associated content. A number of the delimiters passed by the viewer while consuming content can be tracked. A number of times an action key is struck by the viewer while consuming content can also be tracked.

The at least one delimiter can include a delimiter that allows at least one portion of the textual content to be displayed, and prevents the delimited content from being displayed automatically. For example, the delimiter can allow at least one portion of the textual content preceding the delimiter to be displayed, and prevent the delimited content following the delimiter from being displayed automatically.

Preferably, creating a document file does not include writing programming code.

Preferably, inserting the at least one delimiter does not include writing programming code.

The content can also include at least one object tag. The at least one object tag can include formatting tags, hyperlink tags, image source tags, sound source tags, video source tags, table tags, form tags, frame tags, style tags, div tags, class tags, embed tags, object elements, JavaScript, and/or Java applets.

Displaying the document file can include reading the document file using a network interface. For example, the network interface can be a Web browser.

The delimiter can allow the delimited content to be displayed only after a viewer performs a predetermined function. For example, the predetermined function can be movement of an action key, which can be an element of an input device in communication with a microprocessor device that is in communication with the electronic display device.

The delimited content can be additional textual content, which can include additional text. The additional text can include letters, symbols, spaces, numbers, words, sentences, paragraphs, pages, characters, and/or groups of characters. The additional content can include annotation content. Preferably, the additional content is a predetermined amount of textual material that supplements or replaces currently displayed textual material. For example, the additional content can be a new page of textual material. Preferably, the electronic display device defines a size of a page of textual material. The electronic display device can be a dedicated text reader.

The at least one delimiter can include a delimiter that prevents the additional content from being displayed before a viewer moves an action key, and allows the additional content to be displayed after the viewer moves the action key. Alternatively, the at least one delimiter can include a delimiter that prevents annotation content from being displayed before a viewer moves an action key, and allows the annotation content to be displayed after the viewer moves the action key. The action key can be an element of an input device in communication with a microprocessor device that is in communication with the electronic display device.

The delimited content can include pages of text, paragraphs of text, sentences, words, characters, and/or groups of characters.

The document file can be a plaintext file, an HTML file, or an XHTML file.

The method can also include associating the tracked number of delimiters passed by the viewer while consuming content with a monetary charge. A total monetary charge can be increased each time a delimiter is passed by the viewer while consuming content. The viewer can be notified each time a delimiter is passed. A display can be provided to the user showing the total monetary charge.

According to another aspect of the invention, an integrated device includes a storage medium, a microprocessor device, and an electronic display device. The storage medium includes instructions in a document file that can be implemented by the microprocessor device to cause a document to be displayed on the electronic display device according to instructions included in a program file. The instructions in the document file include:
allowing an author to create a file that is a variable computer-readable file that includes content, wherein the content is primarily textual;
allowing the author to insert at least one delimiter at a predetermined position of the textual portion of the document file, defining delimited content;
allowing a viewer to access the document file;
allowing the viewer to consume content of the document file; and
tracking a number of the delimiters passed by the viewer while consuming content.
   The instructions included in the program file are computer-readable instructions that are largely unvarying and include previously programmed computer code allowing the document file to be run.

Allowing the author to insert at least one delimiter can include allowing the author to add delimiting text.

Allowing an author to create a document file can include allowing an author to create a document file according to a standard application program. For example, the standard application program can be a word processing program.

Preferably, allowing an author to create a document file does not include requiring the author to write programming code.

Preferably, allowing the author to insert at least one delimiter does not include requiring the author to write programming code.

Allowing a viewer to access the document file can include allowing at least one portion of the content to be displayed, and preventing the delimited content from being displayed automatically.

Allowing a viewer to access the document file further can include allowing the delimited content to be displayed only after the viewer performs a predetermined function. The integrated device can also include an action key in communication with the microprocessor device, and the predetermined function can be movement of the action key.

The delimited content can include delimited text. The integrated delimited text can include pages of text; paragraphs of text, sentences, words, characters, and/or groups of characters.

The delimited content can be additional textual content, such as additional text, which can include letters, symbols, spaces, numbers, words, sentences, paragraphs, characters, and/or groups of characters.

The additional content can include annotation content.

The additional content can be a predetermined amount of textual material that supplements or replaces currently displayed textual material. For example, the additional content can be a new sentence or paragraph, or a new page, of textual material. Preferably, the electronic display device defines a size of a page of textual material. The electronic display device can be, for example, a dedicated text reader.

The at least one delimiter can include a delimiter that prevents the additional content from being displayed before a viewer moves an action key, and allows the additional content to be displayed after the viewer moves the action key. Alternatively, the at least one delimiter can include a delimiter that prevents annotation content from being displayed before a viewer moves an action key, and allows the annotation content to be displayed after the viewer moves the action key. The action key can be an element of an input device in communication with a microprocessor device that in communication with the electronic display device.

The delimited text can include pages of text, paragraphs of text, sentences, words, characters, and/or groups of characters.

The document file can be a plaintext file, an HTML file, or an XHTML file.

The instructions can also include associating the tracked number of delimiters passed by the viewer while consuming content with a monetary charge. The instructions can also include increasing a total monetary charge each time a delimiter is passed by the viewer while consuming content, and notifying the viewer each time a delimiter is passed. The instructions can also include providing a display to the user showing the total monetary charge.

Thus, the delimited content can be additional textual content, which can include additional text. Preferably, the additional content is a predetermined amount of textual material that supplements or replaces currently displayed textual material. For example, the additional content can be a new page of textual material that appears in a colored box beside the original text. The location of such a colored textual box can be determined through utilization of cascading style sheets by the author, the CSS to be imbedded in the program file. Alternately, an original page of text may be replaced by a new page that is identical to the original page except in formatting of certain words, in ways including color, bolding, italicization, text-size, and highlighting, for example. New textural material may also represent the simple continuation of a sentence or paragraph, or addition of one or more paragraphs, concealed from the viewer before the delimiter has been read by the microprocessor device according to instructions contained within the program file.

### BRIEF DESCRIPTION OF THE DRAWINGS

FIG. 1 is a flow diagram that shows an exemplary general process of the invention.

FIG. 2 is a flow diagram that shows a particular exemplary aspect of the authoring and display processes of the invention.

FIG. 3 is a flow diagram that shows a particular exemplary aspect of the authoring and display processes of the invention.

FIG. 4 is a flow diagram that shows a particular exemplary aspect of the authoring and display processes of the invention.

FIG. 5 is a flow diagram that shows a particular exemplary aspect of the authoring and display processes of the invention.

FIG. 6 is a flow diagram that shows a particular exemplary aspect of the authoring process of the invention.

FIG. 7 is a block diagram of an exemplary integrated device according to the invention.

FIG. 8 is a flow diagram of an exemplary program implementing the invention.

### DETAILED DESCRIPTION OF THE INVENTION

The present invention provides a way for presenting text characters and other content to a viewer, such as a computer user, in predetermined groups, which can be temporally sequenced, according to the depression of one or more predetermined control or action keys or automatically as specified by the author of the content that is being viewed. For example, according to the invention, words, letters, numerals, symbols, blocks of color, digital photographs, graphical images, movies, sound, any other visual and/or audio binary file, forms or interactive forms, and Web pages can be presented on a viewer's display one at a time, or according to any other grouping intended by the author, either in an automatic timed sequence or as controlled by the reader using the action key, as these elements of the document file, and/or delimiters in the document file, are sequentially read by the microprocessor device according to instructions contained in the program file. A single action key will be referred to herein, but the invention is not contemplated necessarily to be limited to a single action key, and more than one key can be designated as action keys if desired.

Thus, according to a particular embodiment of the invention, series of these elements can be presented sequentially to the viewer, wherein the sequencing of the elements is predetermined by the author at the time of authoring the text, and the viewing of the sequence can be controlled by the viewer according to the depression of the action key. For example, certain intermittent interruptions of presentation of the text caused by the authoring process can be ended by the viewer's pressing an action key, such as the Enter key, which will be used herein as a non-limiting example of an action key that can be used according to the method of the invention. Other features, such as pauses in the presentation of the text for any length of time in increments of, for example, tenths of seconds, can be authored into the text so as to affect the viewer's interpretation of what is written in ways that static text cannot provide.

To implement the method of the invention, text is written by an author/programmer so as to be read by a reader's computer, or other microprocessor device, as computer code. This code can be, for example, similar to or no different than ordinary HTML code, yet the method of the invention provides several advantages. The code includes delimiters that the author can use when writing/coding that will halt or pause presentation of text to the viewer at whichever point(s) the author chooses. Thus, for example, words or any grouping of text can be presented a letter at a time with a predetermined delay between individual letters, or a paragraph can be hidden for a predetermined interval before the reader can see it. Alternatively, the paragraph's presentation can be withheld entirely until the action key is depressed. These delimiters can be combined. So, for example, words or any grouping of text can be hidden until the reader has pressed an action key and a further delay predetermined by the author has elapsed.

In a preferred embodiment, the text or other content is authored such that text, or the ordinary language of HTML or XHTML or another compatible language for the Web, is augmented with new time-specific delimiters. The text is coded by the author in “strings” that include the delimiters, wherein each string presents a new screen of text. For example, a string can begin with
LABEL(“. . .
   and end with
. . . )”;
   to identify delimited text, where “LABEL” is a label chosen by the author to designate the delimiter. A first delimiter allows the author to halt the presentation of text on a reader's display until an action key has been struck by the reader, while another delimiter allows the author to pause the presentation of text for a predetermined duration, irrespective of any action by the reader. Although two such delimiters are described herein, additional or different delimiters can be used to provide similar or different time functions, as will be apparent to one of skill in the art. According to the method of the invention, all formatting features of HTML can be used. Retaining the broad feature set capability of HTML provides great advantages to the author.

The sequential presentation of text can also be used to change the format of the text that the reader is reading. For example, the author can author two successive strings of text that vary only in a particular detail, such as encoding to change the color of a word, or to bold, underline, italicize, or alter the font-size text for emphasis. When the reader strikes the action key, all he will see is the change or changes in the selected word, while the remainder of the screen appears to remain the same.

Annotations can also be made to appear and go away at the stroke of the action key. For example, these notes can appear in indented and highlighted boxes, or in any other format of the author's choosing. Highlighting or other emphasis of text can also come and go, timed to change automatically according to the author's specification or on depression of the action key by the viewer.

HTML documents can be made to appear as “pages” that appear on the viewer's screen, one by one, in a timed sequence or at the control of the viewer. For pages to appear in an automatic timed sequence, at the end of each string that makes up a page or one of a set of pages, a delay delimiter can be inserted. For example,
LABEL(“. . . ̂̂25̂ . . . ”);
   or a similar delimiter is inserted, where “̂” is a space, and where “space-space-number-space” is the incremental delay delimiter denoting the number of incremental delay units selected by the author/programmer, here measured in tenths of a second. Likewise, “space-space-vertical pipe-space” (̂̂|̂) can be used as the “stop until the action key is depressed” delimiter, so that pages can change at the control of the viewer. An “automatic blank screen” string, for example,
LABEL(“ ”);
   can be made to occur between ordinary text strings, to generate a momentarily blank screen between screens of text.

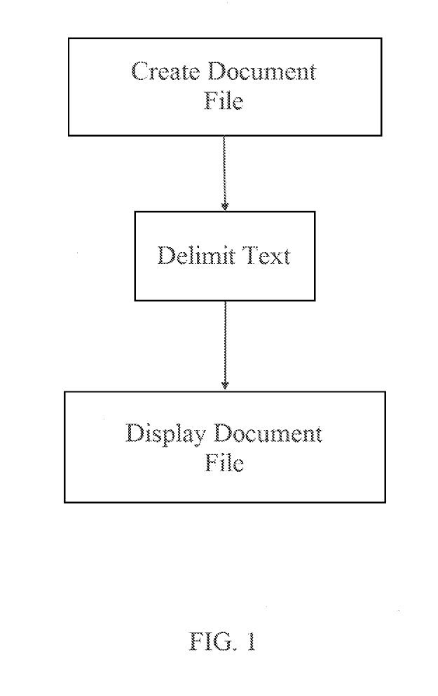

An exemplary general process of the invention is shown in FIG. 1. As shown, the author creates a document file by authoring content that preferably includes text. Predetermined portions of the text are delimited in order to define delimited content. The document file is then read, one character at a time, by a microprocessor device and displayed to a viewer, and the delimited content is displayed differently than other portions of the content of the document file according to the nature of the delimiters chosen by the author/programmer. As previously described, the difference in presentation to the viewer of the delimited content is in the timing of the presentation of text or other elements. The timing differences can be automatic, or controlled by the viewer as specified by the author. The coding of the delimiters can be made transparent to the author, because it is concealed within the program file, so that computer programming skills are not needed at the time of authoring of an article or book. For example, an author may implement any delimiters of his choosing through utilizing the same word processing program used to author ordinary static-text documents. Regardless, delimiters will “drop out,” in the sense that although they will have meaning to the microprocessor running the conjoint document and program files, the viewer will never see the characters or the spaces of the delimiters on his or her screen.

The document file need not only include text, and instead can be a multimedia file including still and moving images and sound as content, any portion of which can be delimited. Further, HTML files and XHTML files can be document files that are authored according to the invention, and any section of such a document can be delimited for timed presentation to a viewer.

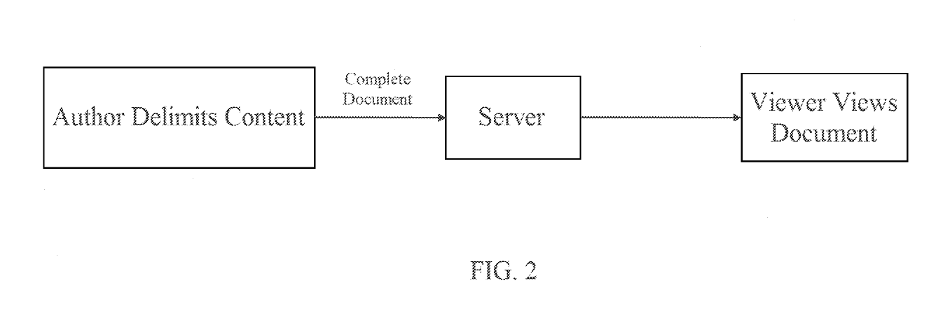

As shown in FIG. 2, as part of the authoring process, the author defines delimited content in the document file, as the document file is first authored, or later, in a separate delimiting action. The viewer will display the document on a microprocessor device such as a computer or dedicated document reader, which will identify the delimited content and present it to the viewer as specified by the author. If the computer or other viewing device is connected to a network, a conjoint document and program file can be stored on a server or in a location at which it can be accessed by a server, and a network interface program can be used to view the document file. Or alternately, the document tile and the program file can be stored in separate locations, particularly if the program file does not need to be altered to run a certain document file. For example, a Web browser running on a notebook computer with a wireless Internet connection can be used to view the document file through reference to the program file, and the document and the program files can be accessed via inserting the Web address of the conjoint document (the document file as this is embedded within the program file) in a browser task bar.

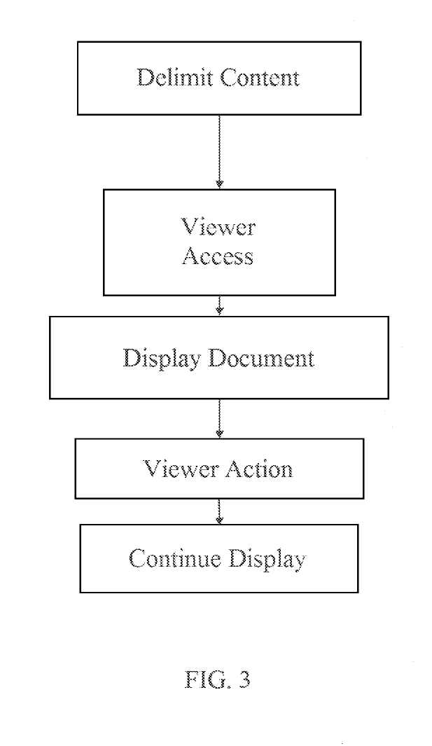

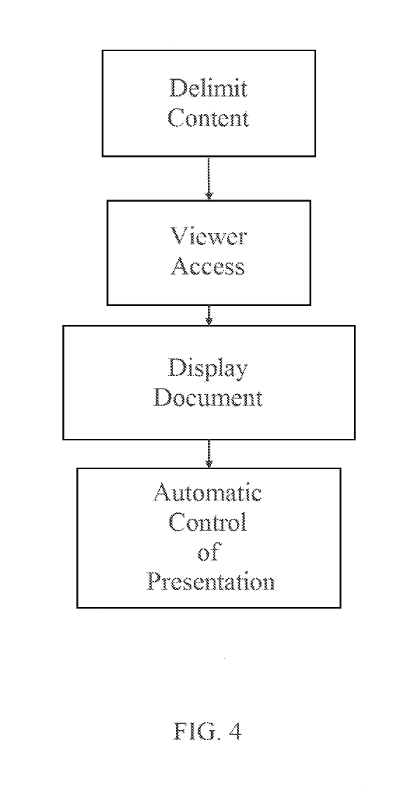

As shown in FIG. 3, the authoring process can include delimiting the content such that further action is required by the viewer to view the document file completely. As previously discussed, this can include the use of an action key. The viewer will be able to display a portion of the document file, but subsequent viewing of delimited content will require additional action as specified by the author.

As shown in FIG. 4, the authoring process can include delimiting the content such that no further action is required by the viewer to view the document file completely, but the presentation of delimited portions of the document file can be delayed as specified by the author. The viewer will be able to display a portion of the document file right away, but viewing of subsequent delimited content will require the viewer to wait. Of course, through the use of both types of delimiters by the author, the timed presentation of the document file to the viewer can be a result of a combination of required action by the viewer, then waiting by the viewer.

As discussed previously, the timed presentation of the content to the viewer can include format changes to the content, such as presenting text in a first format and then in a second format, either automatically or after viewer action. These and other content changes can be effectuated through the use of a sequence of strings to replace displayed content with replacement content. Content can be authored as a sequence of strings, so advancing through the sequence, either automatically or after viewer action, can cause the replacement of content as each new string is read.

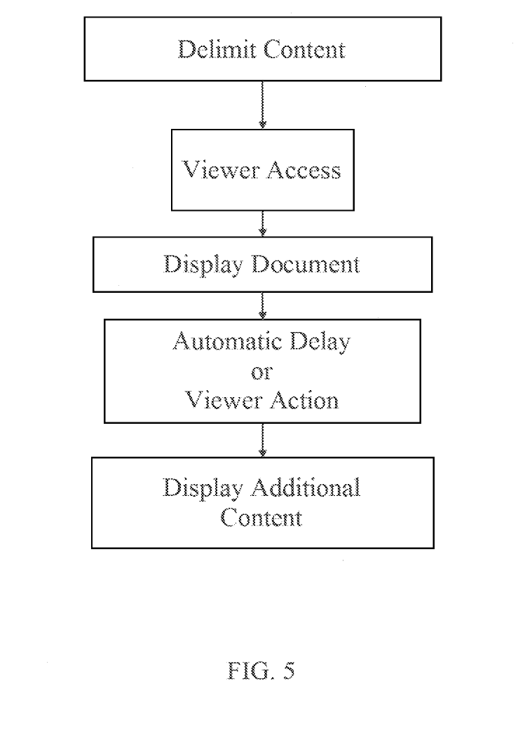

As shown in FIG. 5, the authoring process can include delimiting content that will be added to or replaced after a delay or after viewer action, which content can be added to or replaced again after a further delay or viewer action. This additional content can be displayed concurrently with earlier-displayed portions of the content, or it can replace earlier-displayed portions of the content, either of which can then be changed over time. For example, annotation content can be added after a viewer has read the originally-presented content, and the annotation content or the originally-presented content, or both, can then be changed after the viewer has read the annotation through action by the reader or through passage of a certain time-interval (or both of these sequentially), according to the designs of the author as he created the document file.

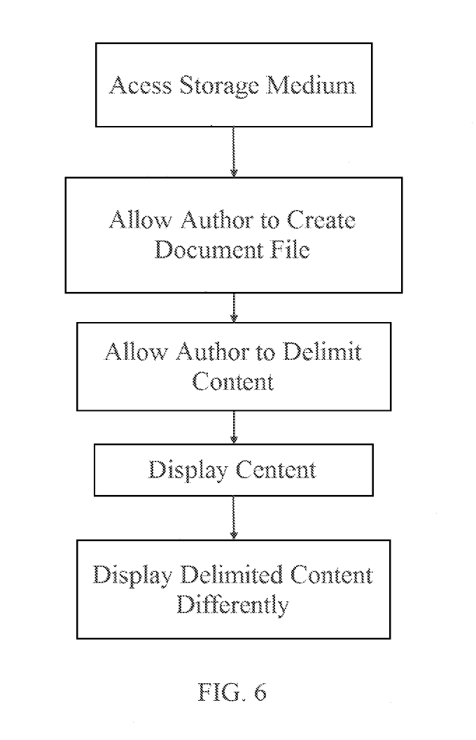

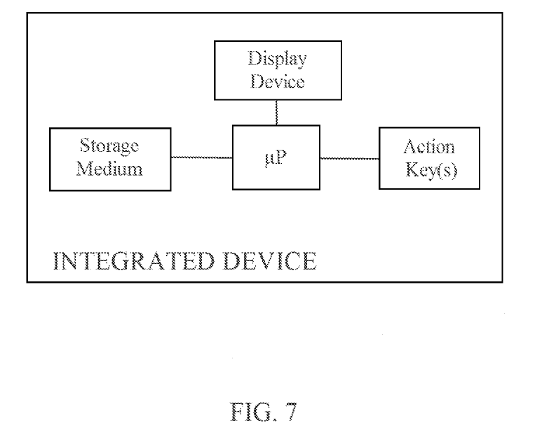

Thus, the authoring process includes creating content and delimiting it so that the timed presentation of the document is controlled, either automatically or by the viewer, or both. The capability to author a document in this manner can be provided by any word processing program This document, now in the sense of a “document file,” can be stored on a medium, such as a portable memory device or a hard drive internal to a computer, or as instructions resident temporarily in RAM. The stored instructions can be implemented by a microprocessor device in conjunction with a program file, either combined with the document file or stored separately, to cause a document to be displayed on an electronic device, as generally shown in FIG. 6.

It is also contemplated that the invention can be embodied as an integrated device that includes the storage medium described above, as well as a microprocessor device and an electronic display device, as shown in FIG. 7. The integrated device can include an action key in communication with the microprocessor device for initiating viewer action.

Other embodiments of the invention can provide additional features. For example, a sequence of strings can be written in such a way as to cause a table of contents to appear after a number of strings has been viewed, which table of contents will be hyperlinked so the process can resume in the hyperlinked document. With or without hyperlinks, an ensuing document can be indefinitely long and will resemble a magazine, newspaper, or book, with any number of pages and any number of articles or chapters. “Chapter jump forward,” “chapter jump back,” and “jump screen behind” features, or other non-sequential access features, can also be provided through the use of one or more additional delimiters. Tables of contents can comprise simple hyperlinked lists, or they can be geometrically more complex shapes, including graphics, digital photographs, and text, created, for example, using HTML's “table” or its Cascading Style Sheets “DIV” functions, preferably hyperlinked. “Advertisement blocks,” possibly hyperlinked to Web pages and possibly authored according to the method of this invention, can also appear on table of contents pages, or anywhere else in the document, including between pages of otherwise-continuous narrative text.

Thus, depending on how the delimiters are used when the document is authored, pages can turn automatically for the reader, with words appearing on, remaining on, and disappearing from the display before the page turns again. Through the thoughtful use of delimiters, any object of text of any size can be designated for such timed presentation, where “object” herein is meant to mean any desired subset of content. For example, poetry can be advantageously displayed as the author prefers that the reader should see it. Words or even portions of words or individual letters, phrases, lines, and stanzas can appear automatically after a suitable delay, giving the reader enough time to read that passage but also allowing the author to provide emphasis by varying the delay for different passages. Alternatively, passages can be presented to the reader one at a time as fixed screens that sequence as the reader depresses the action key. Likewise, passages can be made to disappear as the reader depresses the action key or automatically after a set period of time, or through a combination of both. In the same manner, blocks of color, formatted text, digital photographs, graphics, sound, and so forth, can be used to present a form of artwork to the reader, in a way that appears as a slideshow or even as animation. In the case of animation, a sequence of strings can be authored wherein the text differs between strings, and the strings contain no delimiter except possibly “delay” delimiters, preferably at the end of the strings. In such animation, successive strings can vary minimally, for example only in the formatting or color of previously-existing text, or they can vary substantially, through the addition and/or withdrawal of elements.

Other embodiments of the invention can relate to the tracking of content consumed by the viewer, and to charging a fee for content consumed by a viewer. For example, when an action key is depressed by the viewer as described above or when a “page back” key is pressed, an incremental charge can be incurred, to be debited from a pre-paid account or to be charged at a later time. This charge can be incurred in response to every depression of the action key, forward or backward, or per a pre-determined multiple number of depressions, or according to any scheme devised by the author and implemented as a revision in the program file. If desired, charges can increment as the viewer moves forward through the document, irrespective of action-key depression, depending for example on the reader's passing the end of strings or passing “delay” delimiters.

Alternatively, a special delimiter can be added to the textual content such that “passing” the delimiter by the viewer automatically results in an incremental charge. Such a delimiter might be, for example, “space-space-vertical pipe-number-space,” where the number is variable and indicates the fee assessed in tenths of a dollar. A “mirror” delimiter, such as “space-number-vertical pipe-space-space”, can be added to determine if the viewer has passed certain points in the backward direction, and to increment the charge to the viewer for each passed delimiter.

Using these or similar methods can provide an author with a way to monitor any key depressions and/or forward or backward progression through content, and consumption of content in selectable portions, such as words, paragraphs, pages, etc. This consumption can be tracked and counted, and the viewer can be charged correspondingly.

The content as seen by the viewer can include an indication of the incurred charges, preferably at the reader's option. For example, a small window or other display region can be provided, in which is shown the total charges incurred by the viewer. This display region can also warn the viewer when a charge delimiter has been reached and can provide an indication, such as an audible indication, to the viewer whenever the total amount will be incremented upon the viewer's pressing the action key.

Off-line viewing can also be permitted, with content consumption and associated charges determined when the viewer next logs on to the content-provider's Web site. Because delimiters can be used as described above to limit the viewer's consumption of content without performing acts that can be detected, consumption can be limited by a viewer to remain within a preferred tolerance.

As another feature, through three simple key entries “reversing” the page-advance and page-back key-codes in the program, articles are runnable backwards—to the effect that upon a book's being opened, it will proceed automatically from bottom to top (the strings have to be reversed in sequence). Then when the book or other content is read, all the page changes are absolutely instantaneous. When going forward, or “forward,” through such a document, readers will not see “delay” or “halt” delimiters. However, yet other “mirror” delimiters can be introduced so that the delays would be apparent.

Two different exemplary implementations of the method are described below, one simple and the other more complex. In the simpler version, the text of the document file will always run at full screen, with no specific accommodation made for the presentation of large files, including digital photographs, graphics, movies, or sound, for instance. Therefore, if an author using this implementation wants to present large tiles, the viewer will have to wait while these files download, unless the viewer chooses to advance the page without having seen them. In this simpler version of the invention, each document will comprise a single document file, within which the author's text is inserted appropriately as a series of strings. Therefore, both content and delimiters will be received as a single variable document file on the reader's computer, which document file can be embedded within a substantially invariant, largely pre-coded program file.

In a more complex implementation, once a document is selected by a viewer, as for example by hyperlinking from a table of contents or double-clicking on a file in a storage medium, any large files associated with it, for example, digital photographs, graphics, sound files, and the like, will automatically and in sequence begin to download onto the reader's computer. Thus, by the time the reader reaches the points where these large files would appear, they will more likely have downloaded onto his computer, to be fully available immediately when they are reached by the reader. This provides great advantages for rendering digital photographs, graphics, sound, and the like, within the context of an article, but moreover it permits advertisements to be rendered in any position in an article, with little fanfare.

The more complex implementation will allow advertising to be presented because, for example, an initial “index.html” document can be a “frameset” document that will divide the screen into frames, some of which can include textual advertisements, which will in turn link to hyperlinked pages, which are sites stored on servers preferably by the advertisers themselves and available via the Internet or other network, or locally-stored documents written according to this method or any other. In this case, “index.html” can open in such a way that the main frame will be “targeted” automatically so pages in this main frame automatically “turn” when the action key is depressed, while advertising frames remain static.

Advertisements in the side frames can run sequentially, randomly, or according to some other automatic scheme, being delivered from a central server and changing after an action key has been pressed by the viewer while he is reading the main frame, or after hyperlinks to advertisements, articles, essays, and chapters that are listed in the table of contents have been selected by the viewer and he has ceased to view the main frame at least temporarily.

As another alternative, a document can be written according to this method without frames, with all documents presented in full frame.

In this case, “index.html” can open at full frame without advertisements, and advertisements in side boxes not be displayed until a certain string has been reached by the viewer wherein the advertising side boxes are coded for. The advertising side boxes can be summoned in a like way as the annotation content described above. They can be formatted according to CSS designations. Alternately, they can appear following any ordinary section of text without formatting. Preferably, the advertising side boxes can appear after presentation of content was stopped by a “halt” delimiter, when the viewer presses the action key.

The index.html, tableofcontents.html, and initial advertisement files can be very small (for example, on the order of 20 kB, together), since they can be textual, so they should download quickly regardless of the type of'network connection. However, in the complex implementation, linked advertising files can be quite large and the reader still should not notice these files downloading, because at the time he will be reading initial portions of the article. It is contemplated that the large files will be accessed via the Internet, via a private intranet, or over any network on which the linked server is available to provide the requested page.

Similarly, if the “table” or CSS “DIV” methods of HTML are used to present advertisements rather than the “frames” method, irregular “advertisement blocks” can appear on a table of contents page, which, likewise, might continuously change upon a reader's hyperlinking to an article, the advertisement blocks will not be confined to a frame or a gutter.

Preferably, the advertisements initially present in any of these advertisement blocks or boxes will be purely textual documents, as this will enhance the speed of downloading once the reader reaches the pertinent portion of the document file and they are summoned.

Thus, according to the invention, the author of a document can control the manner in which it is displayed to a reader. Text can be timed to display and change automatically over time according to the author's specifications, or can be advanced only on the depression of one or more action keys, so that portions of the text can be rationed to the reader to suit the author's purpose.

The present invention includes the method as described above. Within the scope of the invention, the method can be implemented as a computer program, which can run on a computer or any device having a processor. The program can be loaded onto the computer directly, or can be implemented over the Internet or any other network. The invention can also be embodied as a storage medium on which is stored instructions that can be interpreted by a processor to cause a computer or other device to perform actions according to the described method, as described above.

The invention can also be embodied as a computer or other device on which the method is performed. For example, a general-purpose computer set up to author text as described herein, or set up on a network or as a stand-alone device and receiving documents authored according to the invention, are both contemplated as falling within the scope of the invention. Further, a special-purpose device dedicated to reading documents authored according to the invention is also contemplated. For example, a document file can be stored on a portable medium that can be loaded onto and read by such a special-purpose device, or document files can be downloaded onto the device via a network or directly from another computer or device. Such a special-purpose “reader” will preferably be portable and will present documents to a viewer. Such a device can be functionally simple, including a display, a single action key, and a pointing device that can move a cursor to navigate the table of contents of a document being read. For example, a portable console having a suitable display can be provided with a touchpad pointing device and a single button, advantageously located for manipulation by a reader. The button can be used as the action key to move a document forward, and in combination with the touch pad can be used to navigate a table of contents. For example, a portable console having a suitable display can be provided on its rear surface with a touchpad pointing device and a single button, advantageously located for manipulation use by the reader as the action key. Lateral movements made with the index finger of one hand on the touchpad device can be translated by the device into vertical movements through the table of contents.

It is also contemplated that more than one action key can be specified, or provided on a dedicated device. For example, the left-arrow key on a typical keyboard can be designated to be used by the viewer to drive the presentation backwards. For example, using this key, a bit of “automatic text” can be viewed more than once. Likewise, the right-arrow key on a typical keyboard can be designated to be used by the viewer to return the document to the point where the viewer had left off, regardless of how many times the left-arrow key and/or the Enter (action) key had been used in the intervening time. Up-arrow and down-arrow keys can be used by the reader to navigate a page longer than a single screen. If a special-purpose device is created dedicated to reading documents authored according to the invention, right-arrow, up-arrow, and down-arrow keys may be added to the rear surface for use by the reader. Alternately, all four keys may be placed on the front of the device, or the screen itself may be utilized as a sensitive touch device, preferably without visual designation of the specific areas of sensitivity.

An additional feature can allow the viewer to interrupt the intended flow of the document. As stated previously, the invention permits any number of screens to unfold automatically on a viewer's display until a “halt” delimiter is reached. There likely will be times when a viewer will want to stop the automatic presentation of text if multiple strings have been coded in succession by an author without a single “halt” delimiter. An additional key can be designated as the interrupt key, by which the viewer can stop the program while it is automatically being presented. In a dedicated device or “reader,” this function can be implemented in a central fifth key or central area on a touch-sensitive display screen.

When viewing a document authored according to the invention, a viewer can advance through a multi-page document effortlessly, without waiting for a link to download. Further, when strings are utilized in the authoring process, the viewer can see content such as text change colors or be highlighted, at the touch of a button, and text can easily be annotated or added to on the present page. Text can be presented automatically, or this and a semi-automatic approach can be combined.

Thus, it is apparent that the invention provides a number of advantages over static text as it is presented in printed books and magazines and in “eBooks.”

Furthermore, whereas eBooks and multipage commercial word-processor documents such as those generated in Microsoft Word, Microsoft PowerPoint, and Adobe Acrobat, necessitate transmission by fast-speed Internet connections because of large file sizes, moderately long articles authored according to this method, if they employ only text, can have file-sizes of only a few tens of kilobytes, allowing long articles or even books to be swiftly downloaded where users are limited to a slow dial-up connection.

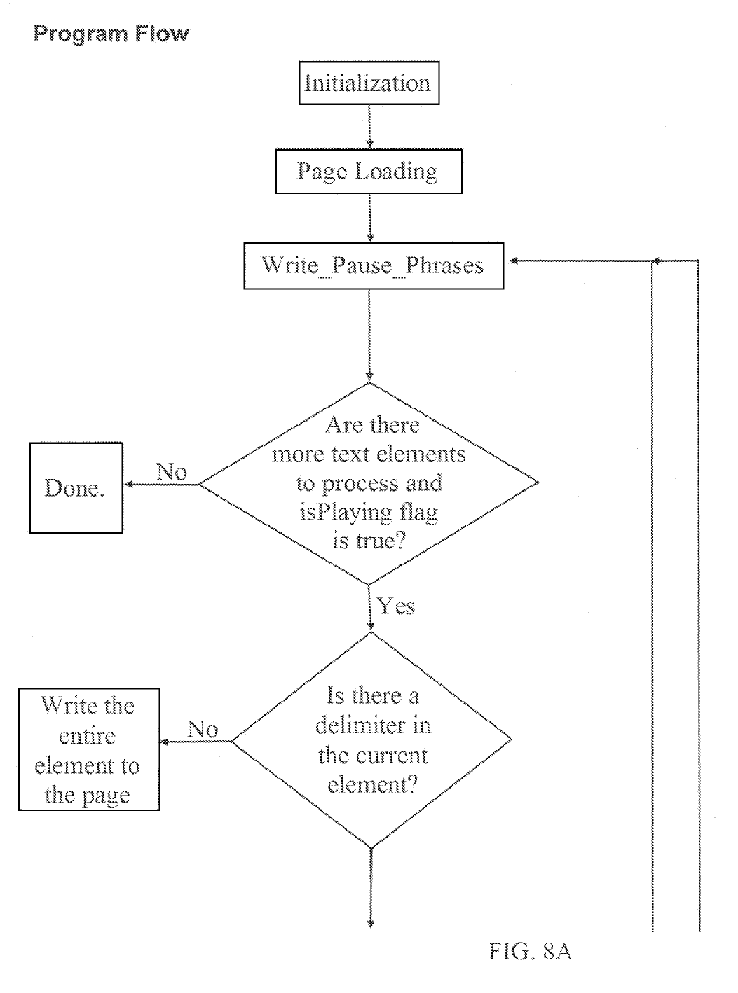

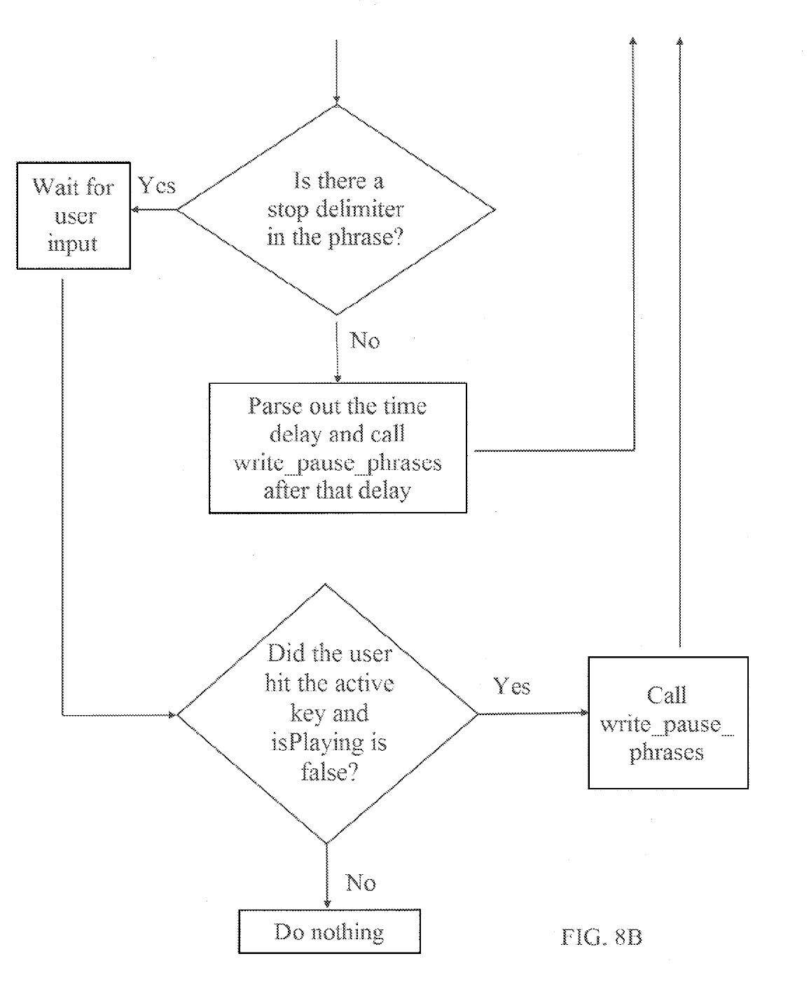

With reference to FIG. 8, an exemplary program description and flow of the invention is now described. This program processes text defined in an array of text elements, specifically strings. Each string can be considered a “page.” Within each of these pages there can be a mix of text, HTML, halt delimiters, and pause delimiters with numbers representing time values. Each text element is processed depending on the delimiters and time values in it. Text elements without any delimiters will be shown all at once. Text elements with “pause” or “stop” delimiters will be processed a letter, word, phrase, paragraph, page, or other element at a time. Where there are stop delimiters, the processing will stop until the viewer depresses the appropriate “activeKey”. Where there are pause delimiters, processing will be delayed by the specified time encoded by the author. While a given text element, preferably a string, is being processed, the phrases will be written to the screen one after another. When processing of one text element is complete, page content is replaced by content defined in the next text element. When the last text element has been processed, all processing will stop.

### Global Variables—The Following Variables are Referenced Throughout the Program

1. STR_DELIM_START—string of one or more characters (or delimiters) used to specify the start of a “phrase”
2. STR_DELIM_END—string of one or more character (or delimiters) used to specify the end of a “phrase”
3. STR_STOP_CHAR—string of one or more characters (or delimiters) used to specify processing stop (requires viewer depressing the activeKey to resume).
4. DELAY_AMOUNT—a number specifying the default delay in milliseconds.
5. aPhrases—an array that holds the “pages” to display.
6. pause_phrases—a string of one or more phrases. These phrases are written to the current page.
7. eol—a boolean specifying the “end of line” flag, set to “true” when the end of a “page” is reached (more specifically the end of an element of the “aPhrases” array).
8. isPlaying—a boolean specifying that a phrase is currently being processed, used to avoid setting multiple delays in the program when the viewer depresses the activeKey in the middle of a delay.
9. currentIndex—a number specifying the current index of the aPhrases array.
10. ActiveKey—a number specifying the keycode of the key that the viewer must press to continue program processing (for example, enter key or an arrow key). Methods
1. PAAT'takes a string “phrase” as entered and adds that string to the global “aPhrases” array, then increments the current index by one. The “phrase” argument may contain any mixed text, html code, delimiters, and time values (numbers).
2. write_delayed—takes a time value as entered, delays processing equivalent to that time value, then calls the write_pause_phrases method.
3. write_pause_phrases—defines which phrases to write to the “page” depending on the state of the program. First, it checks that there are elements in the aPhrases array, that the currentIndex is less than the length of the aPhrases array, and that isPlaying is “true”; if all of these conditions are met, it continues processing, otherwise it does nothing. If there is not a STR_DELIM_START in the current phrase (the element from the aPhrases array defined by the currentIndex), it writes the entire element from the aPhrases array to the “page” and passes processing on to the next element of the aPhrases array. If there is a STR_DELIM_START in the current phrase, it defines the next phrase to process by the STR_DELIM_START and the STR_DELIM_END, resets the current phrase to be the remainder of the current aPhrases element, and checks for a STR_STOP_CHAR. If a STR_STOP_CHAR exists, it stops processing by setting isPlaying to “false” (processing will not continue until the viewer hits the key defined by activeKey). If there is not a STR_STOP_CHAR, it parses out the delay time and sets the local variable “delayAmount” to that time. Then it writes the currently defined pause_phrases to the page by calling WriteLayer with pause_phrases as entered. Finally, it calls itself (write_pause_phrases) after a delay defined by the local variable “delayAmount”.
4. WriteLayer—takes a page element ID (for example “MyLayer”), a parent element ID (deprecated), and text as entered and writes the text to the given page element.
5. Key—takes a window event as entered and calls the appropriate method depending on program state. The write_pause_phrases method will be called as long as there are more “pages” to process in the aPhrases array, isPlaying is “false”, and the key defined by activeKey was pressed. When these conditions are met, isPlaying is set to “true”.

### Process Definitions

1. Initialization. The Following Occurs Before Complete Page Loading:
phrase delimiters (STR_DELIM_START and STR_DELIM_END) are defined to mark the beginning and end of phrases;
the stop delimiter (STR_STOP_CHAR) is defined;
the default time delay (DELAY_AMOUNT) is defined;
the aPhrases array is initialized as an empty array;
the pause_phrases string is initialized as an empty string;
the eol variable is set to “false”;
the isPlaying variable is set to “true”;
the currentIndex is set to 0 (the start of the aPhrases array);
the activeKey is set;
each text element is defined and inserted into the aPhrases array and the currentIndex is incremented;
once all text elements are added, the currentIndex is reset to 0;
the HTML document is set to capture key press events.
   2. Page Loading. When the HTML Page Loads, the write_pause_phrases Method is Called.

Particular exemplary embodiments of the present invention have been described in detail. These exemplary embodiments are illustrative of the inventive concept recited in the appended claims, and are not limiting of the scope or spirit of the invention as contemplated by the inventor.

I claim:

1. A method of governing content presentation, comprising:
creating a document file, wherein the document file is a variable computer-readable file that includes content, wherein the content is primarily textual;
inserting at least one delimiter at a selected position of the textual portion of the document file, defining delimited content;
providing the document file to a viewer;
accessing the document file by the viewer;
consuming content of the document file by the viewer; and
tracking predetermined events and/or actions that occur while the viewer consumes content.

2. The method of claim 1, wherein tracking predetermined events and/or actions that occur while the viewer consumes content includes tracking a number of the delimiters passed by the viewer while consuming content, and/or tracking a number of times that the viewer depresses a designated action key, and/or tracking the number of textual elements passed by the viewer while consuming content.

3. The method of claim 2, further comprising associating a monetary charge with the tracked number of delimiters passed by the viewer, and/or the tracked number of times that the viewer depresses a designated action key, and/or the tracked number of textual elements passed by the viewer while consuming content.

4. The method of claim 3, further comprising increasing a total monetary charge each time a delimiter is passed by the viewer and/or each time the action key is depressed, and/or each time the number of textual elements is passed while consuming content.

5. The method of claim 4, further comprising notifying the viewer each time the total monetary charge is increased.

6. The method of claim 4, further comprising providing a display to the user showing the total monetary charge.

7. The method of claim 2, wherein the predetermined event and/or action is tracking the number of textual elements passed by the viewer while consuming content, wherein the textual element is a string.

8. The method of claim 1, wherein the at least one delimiter includes a delimiter that allows at least one portion of the textual content to be displayed, and prevents the delimited content from being displayed automatically.

9. The method of claim 8, wherein the at least one delimiter includes a delimiter that allows at least one portion of the textual content preceding the delimiter to be displayed, and prevents the delimited content following the delimiter from being displayed automatically.

10. The method of claim 1, wherein creating a document file does not include writing programming code.

11. The method of claim 1, wherein inserting the at least one delimiter does not include writing programming code.

12. The method of claim 1, wherein the content further includes at least one data tag.

13. The method of claim 12, wherein the at least one object tag includes at least one of formatting tags, hyperlink tags, image source tags, sound source tags, video source tags, table tags, form tags, frame tags, style tags, div tags, class tags, embed tags, object elements, JavaScript, and Java applets.

14. The method of claim 1, wherein displaying the document file includes reading the document file using a network interface.

15. The method of claim 14, wherein the network interface is a Web browser.

16. The method of claim 1, wherein the delimiter allows the delimited content to be displayed only after a viewer performs a predetermined function.

17. The method of claim 16, wherein the predetermined function is movement of an action key, wherein the action key is an element of an input device in communication with a microprocessor device that is in communication with the electronic display device.

18. The method of claim 1, wherein the delimited content is additional textual content.

19. The method of claim 18, wherein the additional content includes additional text.

20. The method of claim 19, wherein the additional text includes at least one of letters, symbols, spaces, numbers, words, sentences, paragraphs, pages, characters, and groups of characters.

21. The method of claim 19, wherein the additional content includes annotation content.

22. The method of claim 19, wherein the additional content is a predetermined amount of textual material that supplements or replaces currently displayed textual material.

23. The method of claim 19, wherein the additional content is a new page of textual material.

24. The method of claim 23, wherein the electronic display device defines a size of a page of textual material.

25. The method of claim 24, wherein the electronic display device is a dedicated text reader.

26. The method of claim 18, wherein the at least one delimiter includes a delimiter that prevents the additional content from being displayed before a viewer moves an action key, and allows the additional content to be displayed after the viewer moves the action key, wherein the action key is an element of an input device in communication with a microprocessor device that is in communication with the electronic display device.

27. The method of claim 18, wherein the at least one delimiter includes a delimiter that prevents annotation content from being displayed before a viewer moves an action key, and allows the annotation content to be displayed after the viewer moves the action key, wherein the action key is an element of an input device in communication with a microprocessor device that in communication with the electronic display device.

28. The method of claim 1, wherein the delimited content includes one or more of pages of text, paragraphs of text, sentences, words, characters, and groups of characters.

29. The method of claim 1, wherein the document file is one of a plaintext file, an HTML file, and an XHTML file.

30. An integrated device comprising a storage medium, a microprocessor device, and an electronic display device;
wherein the storage medium comprises instructions in a variable document file that can be implemented by the microprocessor device to cause a document to be displayed on the electronic display device according to instructions included in a program file,
wherein the instructions in the document file include:
allowing an author to create variable computer-readable content as a portion of the document file, wherein the content is primarily textual;
allowing the author to insert at least one delimiter at a predetermined position of the textual portion of the document file, defining delimited content;
allowing a viewer to access the document file;
allowing the viewer to consume content of the document file; and
tracking predetermined events and/or actions that occur while the viewer consumes content; and
wherein the instructions included in the program file are a computer-readable instructions that are largely unvarying and include previously programmed computer code allowing the document file to be executed.

31. The integrated device of claim 30, further comprising associating the document file with a computer programmer-coded, pre-coded, and largely invariant program file that governs presentation of the variable document file, wherein the viewer is allowed to access the document file according to rules imposed by the program file.

32. The integrated device of claim 30, wherein tracking predetermined events and/or actions that occur while the viewer consumes content includes tracking a number of the delimiters passed by the viewer while consuming content, and/or tracking a number of times that the viewer depresses a designated action key, and/or tracking the number of textual elements passed by the viewer while consuming content.

33. The integrated device of claim 32, wherein the event is tracking the number of textual elements passed by the viewer while consuming content, and the textual element is a string.

34. The integrated device of claim 32, wherein the instructions further include associating a monetary charge with the tracked number of delimiters passed by the viewer, and/or the tracked number of times that the viewer depresses a designated action key, and/or the tracked number of textual elements passed by the viewer while consuming content.

35. The integrated device of claim 34, wherein the instructions further include increasing a total monetary charge each time a delimiter is passed by the viewer while consuming content.

36. The integrated device of claim 35, wherein the instructions further include notifying the viewer each time a delimiter is passed.

37. The integrated device of claim 35, wherein the instructions further include providing a display to the user showing the total monetary charge.

38. The integrated device of claim 30, wherein allowing the author to insert at least one delimiter includes allowing the author to add delimited text.

39. The integrated device of claim 30, wherein allowing an author to create a document file includes allowing a author to create a document file according to a standard application program.

40. The integrated device of claim 39, wherein the standard application program is a word processing program.

41. The integrated device of claim 30, wherein allowing an author to create a document file does not include requiring the author to write programming code.

42. The integrated device of claim 30, wherein allowing the author to insert at least one delimiter does not include requiring the author to write programming code.

43. The integrated device of claim 30, wherein allowing a viewer to access the document file includes allowing at least one portion of the content to be displayed, and preventing the delimited content from being displayed automatically.

44. The integrated device of claim 43, wherein allowing a viewer to access the document file further includes allowing the delimited content to be displayed only after the viewer performs a predetermined function.

45. The integrated device of claim 44, further comprising an action key in communication with the microprocessor device, wherein the predetermined function is movement of the action key.

46. The integrated device of claim 30, wherein the delimited content includes delimited text.

47. The integrated device of claim 46, wherein the delimited text includes one or more of pages of text, paragraphs of text, sentences, words, characters, and groups of characters.

48. The integrated device of claim 30, wherein the delimited content is additional textual content.

49. The integrated device of claim 48, wherein the additional content includes additional text.

50. The integrated device of claim 49, wherein the additional text includes at least one of letters, symbols, spaces, numbers, words, sentences, paragraphs, characters, and groups of characters.

51. The integrated device of claim 49, wherein the additional content includes annotation content.

52. The integrated device of claim 49, wherein the additional content is a predetermined amount of textual material that supplements or replaces currently displayed textual material.

53. The integrated device of claim 52, wherein the additional content is anew sentence of textual material, a new paragraph of textual material, or a new page of textual material.

54. The integrated device of claim 53, wherein the electronic display device defines a size of a page of textual material.

55. The integrated device of claim 54, wherein the electronic display device is a dedicated text reader.

56. The integrated device of claim 48, wherein the at least one delimiter includes a delimiter that prevents the additional content from being displayed before a viewer moves an action key, and allows the additional content to be displayed after the viewer moves the action key, wherein the action key is an element of an input device in communication with the microprocessor device that is in communication with the electronic display device.

57. The integrated device of claim 48, wherein the at least one delimiter includes a delimiter that prevents annotation content from being displayed before a viewer moves an action key, and allows the annotation content to be displayed after the viewer moves the action key, wherein the action key is an element of an input device in communication with a microprocessor device that in communication with the electronic display device.

58. The integrated device of claim 30, wherein the delimited text includes one or more of pages of text, paragraphs of text, sentences, words, characters, and groups of characters.

59. The integrated device of claim 30, wherein the document file is one of a plaintext file, an HTML file, and an XHTML file.
